(19) United States
(12) Patent Application Publication
(10) Pub. No.: US 2007/0022130 A1
(43) Pub. Date: Jan. 25, 2007

(54) Systems and methods for providing commercial loops

(76) Inventors: Prescott V Lee, Menlo Park, CA (US); Kyle S. Mashima, Menlo Park, CA (US)

Correspondence Address: CARR & FERRELL LLP, 2200 GENG ROAD, PALO ALTO, CA, 94303, US

(21) Appl. No.: 11/478,938

(22) Filed: Jun. 30, 2006

Related U.S. Application Data
(60) Provisional application No. 60/696,029, filed on Jul. 1, 2005.

(51) Int. Cl. G06F 7/00

(52) U.S. Cl. 707/100

(57) ABSTRACT

Systems and methods for providing a commercial loop are provided. In exemplary embodiments, an offer for the commercial loop is presented to a user. Upon receiving a request from the user, the commercial loop is provided to the user. Modifications to the commercial loop may be made by a content provider associated with the commercial loop. Additionally, the commercial loop may be customized to the user.

### CROSS-REFERENCE TO RELATED APPLICATIONS

The present application claims the benefit and priority of U.S. provisional patent application Ser. No. 60/696,029 filed on Jul. 1, 2005 and entitled “Systems and Methods for Placing Content from a Commercial Server into a Loop,” which is hereby incorporated by reference.

This application is related to co-pending U.S. application Ser. No. 11/173,601, entitled “Systems and Methods for Providing Loops,” filed on Jul. 1, 2005, co-pending U.S. application Ser. No. 11/173,255, entitled “Systems and Methods for Single Act Media Sharing,” filed on Jul. 1, 2005, co-pending U.S. application Ser. No. 11/173,552, entitled “Systems and Methods for Providing an Interface for Interacting with a Loop,” filed on Jul. 1, 2005, co-pending U.S. application Ser. No. 11/173,691, entitled “Systems and Methods for Single Input Installation of an Application,” filed on Jul. 1, 2005, and co-pending U.S. application Ser. No. 11/173,211, entitled “Loop Channels,” filed on Jul. 1, 2005, which are herein incorporated by reference.

### BACKGROUND OF THE INVENTION

1. Field of the Invention

The present invention relates generally to media, and more particularly to systems and methods for utilizing commercial loops.

2. Description of Related Art

In order to organize data, such as documents, images, pictures, audio files, other media, a user traditionally creates a file system for storing and locating these items. Related items are often stored in the same folder and organized by a file directory. The file directory allows the user to store and locate items according to a tree system, where files are stored within folders, which may be within other folders, and so on.

When the user elects to view the items, the user can browse the file directory in order to locate the particular item and open the item for display. If the user wants to group several items together, the user can store the items as files within the same folder and open each file in order to view the file contents. Another way the user can group the items together is by saving the items to one file, as a single document. In this case, the user need only open the single file to display the contents of the single document. The user can scroll down the document to display the contents.

With the advent of the Internet, computer users may store data from various websites on their computing device. Traditionally file directories for storing text documents and other types of items are not always as convenient for web-based data, such as images or streaming media obtained from various websites. While software applications exist for organizing digital still images, the user is required to search for particular still images. Furthermore, these software applications do not contemplate use of streaming media.

Additionally, the users may desire to share data with other users. Conventionally, media is communicated from one user to a second user through a long series of steps. For instance, the user may access a file containing the media in a directory on the user's computing device to locate the media the user wishes to share. Upon locating the media, the user may select the file and select an option, such as “send file by electronic mail.” When the “send file by electronic mail” option is selected, an electronic mail window opens in which the user can enter text and send the file containing the media to a second user. Alternatively, the user may open an electronic mail window, attach the file, and send an electronic mail message along with the attachment to the second user. The process of communicating media from one computing device to another can take several minutes, because of the number of steps involved in locating, addressing, and sending the media to specified users.

The second (receiving) user can then open the received file to view the media in the file. Typically, only one file may be opened and viewed at a time. Additionally, the second user may not know the content of the file until the file is opened.

Although various systems are available for organizing and sharing data, the data generally is displayed and shared one file at a time or as a predetermined grouping of files. Therefore, there is a need for systems and methods for providing loops utilizing commercial media.

### SUMMARY OF THE INVENTION

Embodiments of the present invention provide exemplary systems and methods for providing a commercial loop. In exemplary embodiments, an offer for the commercial loop is presented to a user. The offer may be provided on a website of a content provider. In alternative embodiments, the offer may be provided via an invitation to the user. Additionally, the user may search for specific commercial loops available from a server.

The user may then select the commercial loop by providing a request for the commercial loop. The request may comprise, for example, “dragging and dropping” the commercial loop onto a media engine associated with the user, clicking, selecting, or otherwise activating a link associated with the commercial loop, or subscribing to the commercial loop.

Upon receiving the request from the user, the commercial loop is provided to the user. In some embodiments, a copy of the commercial loop is stored onto a media engine associated with the user. Alternatively or in addition, an identifier associated with the commercial loop may be stored onto the user's media engine. The commercial loop may then be displayed on a loop player on the media engine.

Modifications to the commercial loop may be made by a content provider associated with the commercial loop. The modifications are then provided to the users that have the same commercial loop. The modifications may be provided directly by the content provider. Alternatively, the content provider provides the modifications to the server, which in turn forwards the modification to the appropriate users. Modifications comprise changes to items of media in the commercial loop or changes to the entire commercial loop.

Additionally, the commercial loop may be customized to the user. The customization may be based on preferences, past behavior, spending habits, and/or commercial loops subscribed to, for example.

### BRIEF DESCRIPTION OF THE DRAWINGS

FIG. 1 is an exemplary screenshot of a loop on a loop player, in accordance with one embodiment;

FIG. 2 is block diagram of an exemplary environment for practicing the present invention;

FIG. 3 is an exemplary block diagram of a media engine;

FIG. 4 is an exemplary block diagram of components associated with a server;

FIG. 5 is an exemplary flowchart of a method for maintaining a commercial loop at a client; and

FIG. 6 is an exemplary flowchart for a method of processing the commercial loop at the server.

### DESCRIPTION OF EXEMPLARY EMBODIMENTS

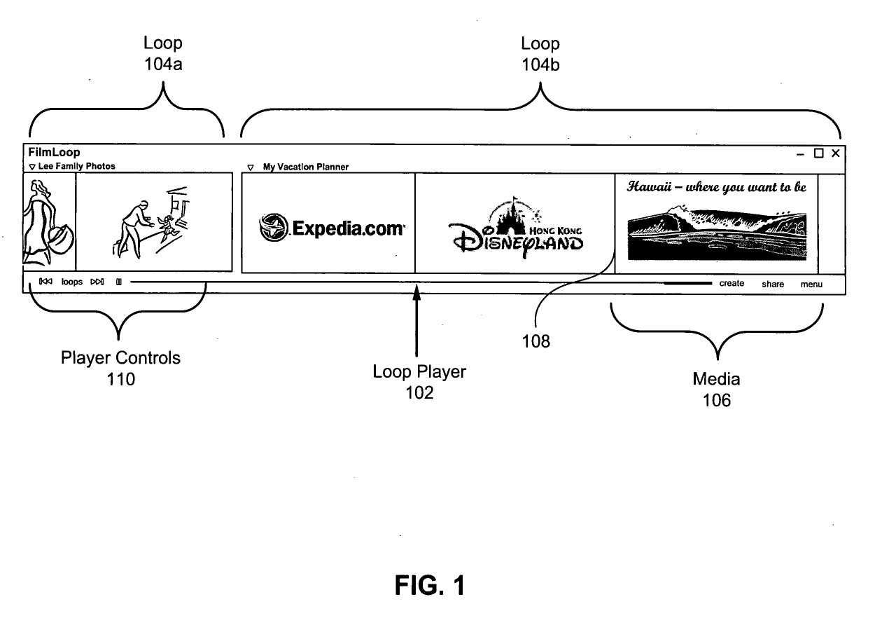

Embodiments of the present invention provide systems and methods for utilizing loops comprising commercial media. A loop is an automatically moving display of a plurality of media. FIG. 1 is a screenshot of an exemplary loop player 102 operating on a computing device. The computing device may be, for example, a personal digital assistants (PDAs), mobile phones, or personal computer. The loop player 102 displays loops 104a and 104b. Any number of loops 104 may be displayed by the loop player 102. In exemplary embodiments, the loops 104 scroll across the loop player 102.

Each loop 104 comprises various items of media 106. The media 106 may comprise photos, video, audio, images, text, advertisement, and any other type of data. The media 106 may appear as one or more items separated by a line, frame, or any other separation device 108 for defining the one or more items of media 106 in the loop 104. Each item of media 106 may, itself, include moving displays, videos, or further media. The media 106 can be manipulated by the user, as will be described in more detail hereinafter.

As shown in the present embodiment, portions of two loops 104a and 104b are being displayed at the same time. A first loop 104a is entitled “Lee Family Photos.” This first loop 104a is a personal loop 104 comprising personal media that a user has compiled. A second loop 104b is entitled “My Vacation Planner.” This second loop 104 is a commercial loop. In exemplary embodiments, a commercial loop is a loop associated with an entity, which may comprise advertisement or information for some product or service provided by the entity, or for which the user pays a fees to view. In the present example, the second loop 104b is associated with Expedia.com. Within the second loop 104b, a plurality of media 106 items related to different vacation destinations are provided. For example, one item of media 106 of the second loop 104b is a media 106 for Hong Kong Disneyland. By selecting this media 106, further information or media with regards to Hong Kong Disneyland will be provided (e.g., ticket prices, airfare, a video of the Park).

Any combination of personal and commercial loops 104 may be displayed. For example, the loop player 102 may continuously play only commercial loops 104, the loop player 102 may alternate between a commercial loop 104 and a personal loop 104, or the loop player 102 may play a commercial loop 104b after every fifth personal loop 104a.

Player controls 110 are provided on the loop player 102 for manipulating movement and/or scrolling of one or more loops 104. The loops 104 may be manipulated by a user of the loop player 102 to, for example, stop, speed up, slow down, or change direction of the scrolling. The player controls 110 are exemplary, and any type of mechanism may be provided for manipulating the loops 104. Furthermore, any type of manipulation of loops 104 is within the scope of embodiments of the present invention.

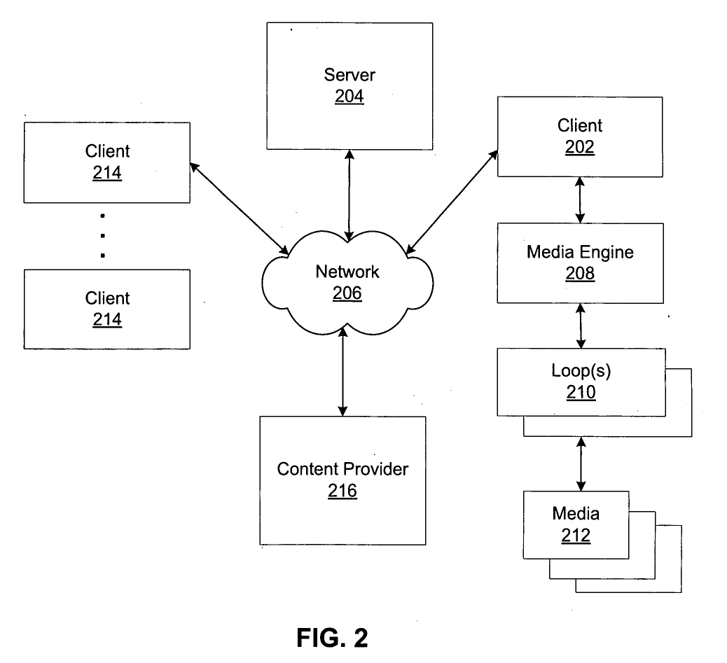

Referring now to FIG. 2, an exemplary environment for practicing embodiments of the present invention is shown. According to exemplary embodiments, the environment comprises a client 202 coupled to a server 204 via a network 206. The client 202 may be any computing device (e.g., laptop, mobile phone, PDA, etc.) associated with a user. The server 204, in this embodiment, is a loop server. Embodiments of the present invention will now be discussed with reference to commercial loops.

The client 202 is coupled to a media engine 208 that provides the loop player 102 for displaying at least one commercial loop 210 comprising media 212 on a display device of the client 202. In some embodiments, the media engine 208 resides on the client 202. In yet a further embodiment, the media engine 208 is coupled to the client 202 via the network 206.

The process of providing loops, including generating loops, is described in further detail in co-pending U.S. application Ser. No. 11/173,601, entitled “Systems and Methods for Providing Loops,” filed on Jul. 1, 2005, which is incorporated by reference. The process of providing an interface for interacting with a loop is described in further detail in co-pending U.S. application Ser. No. 11/173,552, entitled “Systems and Methods for Providing an Interface for Interacting with a Loop,” filed on Jul. 1, 2005, which is incorporated by reference.

In exemplary embodiments, a user of the client 202 may share one or more commercial loops 210 with further clients 214. The further clients 214 may also have, or be coupled to, media engines (same or similar to media engine 208) for playing the commercial loops 210. The process of sharing media is described in further detail in co-pending U.S. application Ser. No. 11/174,305, entitled “Systems and Methods for Sharing Loops,” filed on Jul. 1, 2005, which is incorporated by reference.

In exemplary embodiments, the content provider 216 provides the media 212 within the commercial loop 210. The content provider 216 may be a commercial server, an advertisement server, and any other device associated with an entity providing commercial media 212 for the commercial loop 210. Commercial media may comprise advertisements, product and service information, or media that the user pays a fee to view (e.g., subscribes to).

In some embodiments, the content provider 216 generates the commercial loops 210. For example, the content provider 216 will create a blank loop commercial loop 210 and add commercial media 212 to the commercial loop 210. The commercial loop 210 may be created at the content provider 216, at the server 204, or at a combination of both.

The commercial loops 210 are then made available for a user to select and provide to their media engine 208. For example, the content provider 216 may be Expedia.com, and the commercial loop 210 may be placed on their website. The user can then select the commercial loop 210 for their media engine 208 by “dragging and dropping” the commercial loop 210 to their media engine 208, activating a switch, button, or link that provides a copy of the commercial loop 210 to the media engine 208, or utilizing any other mechanism for selecting the commercial loop 210. In alternative embodiments, identifiers associated with the commercial loops 210 are stored to the media engine 208 in lieu or, or in addition to, the commercial loops 210, as will be discussed further below.

In one embodiment, the content provider 216 can specify how often particular media 212 appears within the commercial loop 210. For example, the content provider 216 may specify that the Hong Kong Disneyland media should appear no less than between every 20^{th} item of media 212 within the commercial loop 210. The content provider 216 can also specify, according to one embodiment, how often its commercial loop 210 appears on the loop player 102.

In exemplary embodiments, an identifier is associated with each commercial loop 210 and/or item of media 212. The loop identifier may be unique within the network 206 and may comprise any type of identifiers. In one embodiment, the loop identifier is associated with the commercial loop 210 when the commercial loop 210 is created. Alternatively, the loop identifier may be associated with the commercial loop 210 when the user at the client 202 adds (e.g., drags and drops) the commercial loop 210 into their loop player 102. In further embodiments, the server 204 assigns the identifiers.

The content provider 216 may also modify the commercial loop 210. When the content provider 216 makes a modification to the commercial loop 210 that has been provided to one or more clients 202 or 214, the clients 202 or 214 receives the same modifications to the commercial loop 210 as an update. In one embodiment, the commercial loop 210 is tracked via the associated identifier. Thus, a modification to a commercial loop 210 having a particular identifier will be sent to all clients 202 or 214 having loops with the same identifier. In one embodiment, the server 204 provides the modifications to the commercial loop 210 on the client 202 or 214 at any time after the content provider 216 makes the modification to the commercial loop 210. Because the server 204 may automatically distribute modifications to the client 202 or 214 with commercial loops 210 having the same identifier, only a single act is required by the content provider 216 to share the modifications with users at the client 202 or 214.

According to one embodiment, the server 204 makes requests to the content provider 216 at various times for modifications made to the commercial loop 210 by the content provider 216, and provides the modification to the clients 202 and 214 that have commercial loops 210 with the same identifier. As discussed herein, the updates may include any modification to items of media 212, the commercial loop 210 comprising the media 212, and/or metadata associated with the commercial loops 210 or items of media 212.

In a further embodiment, the content provider 216 can “push” the modifications to the commercial loops 216. The modifications may be pushed immediately upon the implementation of the modification, at predetermined intervals, or any other time determined by the content provider 216. The modifications may be pushed to the server 204, which will then provide the modifications to the clients 202 and 214. Alternatively, the modifications may be pushed directly to the clients 202 and 214 having the commercial loop 210 with the same identifier.

In exemplary embodiments, the content provider 216 (e.g., vendor, retailer, advertiser, etc.) may make commercial loops 210 available for subscription. Users may subscribe to the commercial loops 210, for example, by registering with the content provider 216. For the users that subscribe to a particular commercial loop 210, updates may be automatically received when the content provider 216 makes modifications to the commercial loop 210.

In some embodiments, a user's preferences and/or behaviors (e.g., spending habits, types of commercial loops scribed to, etc.) may be stored at the server 204 or the content provider 216 in association with the subscription. In this manner, the content provider 216 or the server 204 may provide media 212 or commercial loops 210 that are customized to the user's preferences and behaviors.

Once the commercial loops 210 have been set up by various users and assigned unique identifiers, the server 204 and/or the media engine 208 keeps track of the commercial loops 210 and any changes thereto. Accordingly, since the server 204, in some embodiments automatically distributes the updates to the client 202 and 214 having the commercial loops 210 with shared identifiers, only a single act is required by the content provider 216 to share the updates to the commercial loop 210 with the users at the clients 202 and 214.

In exemplary embodiments, master copies of the commercial loops 210 may be stored on the server 204. Further, the server 204 may comprise an index for locating the master copy of the commercial loop 210. In one embodiment, the index may comprise a list of the identifiers. The content provider 216 may modify the master copy on the server 204 by accessing the server 204 via the network 206. Alternatively, the master copy of the commercial loop 210 may be stored at the server 204, while the content provider 216 utilizes the index to retrieve the particular commercial loop 210 to their computing device for viewing and modification. Any storage medium may be utilized for storing the commercial loop 210, copies of the commercial loop 210, metadata, and/or indices.

In further embodiments, the server 204 may store versions of the commercial loops 210. Thus, the server 204 may maintain different versions of the same commercial loop 210. Additionally, the client 202 or 214 may store different versions of the commercial loop 210. Both the server 204 and the clients 202 and 214 may maintain an index for organizing and tracking the various versions of the commercial loops 210. The identifiers assigned to the different versions may, in exemplary embodiments, be similar to reflect the version (e.g., identifier#.1 for the first version and identifier#.2 for the second version).

It will be appreciated by those skills in the art that the content provider 216 and the clients 202 and 214 may be a part of a peer-to-peer network where no external server 204 is necessary. In some embodiments, the content provider 216 on a peer-to-peer network assigns an identifier to the commercial loop 210 and/or the items of media 212 contained within the commercial loop 210. In other embodiments, the content provider 216 functions as the server 204 on a peer-to-peer network. For example, the content provider 216 may function as the server 204 for all commercial loops 210 created by the content provider 216. In this example, the content provider 216 will assign permanent identifiers for the items of media 212 within the commercial loop 210.

It should be noted that embodiments of the content provider 216 as referred to herein can embody a user at the content provider 216. For example, the user at the content provider 216 can subscribe to the commercial loop 210.

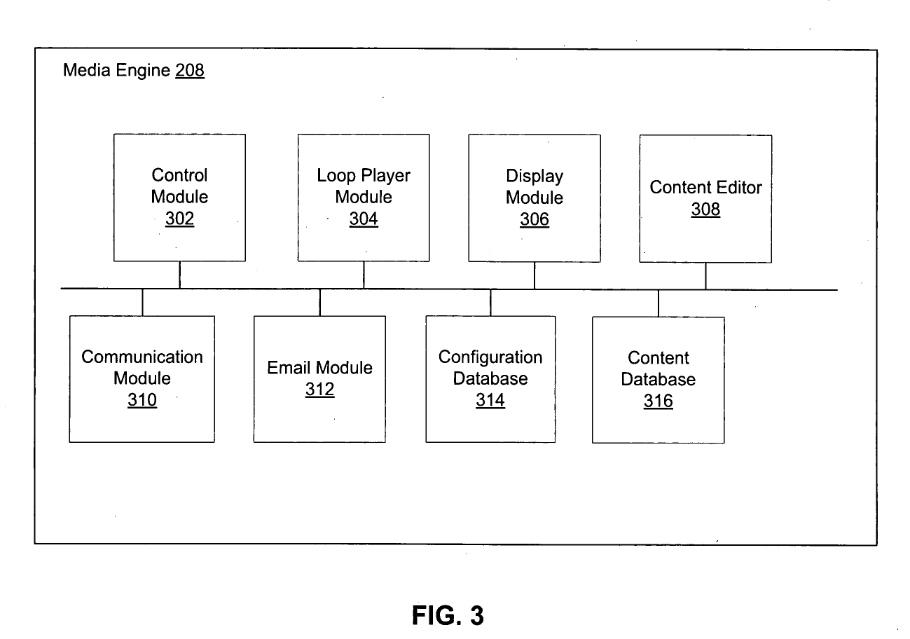

Referring now to FIG. 3, a block diagram of the exemplary media engine 208 is shown. According to one embodiment, a control module 302 manipulates the items of media 212 and graphically constructs the commercial loop 210 having the items of media 212 for display. The control module 302 can also specify a default speed at which the commercial loop 210 plays. Additionally, the control module 302 may coordinate the insertion, at specific times or intervals, of specified items of media from the content provider 216 into the commercial loop 210. For example, the control module 302 may determine when to insert a modification received from the content provider 216.

A loop player module 304 plays the commercial loops 210. As previously discussed, the commercial loops 210 may be displayed along with personal loops 104a. In exemplary embodiments, the user may choose from on-screen selections (e.g., buttons or drop down menus), manipulate on-screen items (e.g., dragging and dropping the commercial loops 210), or issue voice commands to control the display of the personal loops 104a and the commercial loops 210. In one example, the loop player module 304 may also be used to control a direction and speed of the personal loops 104a and the commercial loops 210. For example, when the user utilizes the player controls (similar to the player controls 110 of FIG. 1) to adjust the commercial loop 210, the loop player module 304 receives the instructions from the player controls and adjusts the commercial loop 210 accordingly.

A display module 306 presents a graphical user interface (GUI) through which the loop player 102 may be displayed. Within the loop player 102, any number of personal loops 104a and commercial loops 210 may be viewed. The display module 306 also provides various modification interfaces on the loop player 102 through which users may modify the personal loops 104a and commercial loops 210. Such modification interfaces include, for example, drop down menus and player controls.

An exemplary content editor 308 allows the user to make adjustments to the personal loops 104a, and in some embodiments, to the commercial loops 210. The user can use the content editor 308 to resize or rotate media 212 in the commercial loop 210, or configure or format the items of media 106 in the personal loop 104a, for example. Additionally, the user may resize an image or change a font type associated with the item of media 106.

An exemplary communication module 310 allows the media engine 208 to utilize facilities of the client 202 for communicating with the server 204. The communications may include providing and receiving updates for the commercial loops 210 running in the media engine 208, and to transfer any other data between the media engine 208 and the server 204.

An email module 312 may be provided as a communication interface for electronic mails. The email module 312 is utilized to send and receive media 212, commercial loops 210, metadata, or identifiers associated with the commercial loops 210 with other users. In a further embodiment, the email module 312 may also send invitations to other users to access sharable commercial loops 210.

The exemplary media engine 208 may comprise a configuration database 314. The configuration database 314 stores identifiers associated with the items of media 212 and the commercial loops 210. In further embodiments, the configuration database 314 stores any type of data related to the media engine 208 (e.g., information regarding the client 202, type and quality of attached network 206, communication performance, registration information for the client 202, preferences of the user at the client 202, version numbers for the commercial loops 210). In a further embodiment, the configuration database 314 may be located outside of the media engine 208, and is accessible via a configuration database interface in the media engine 208.

The exemplary media engine 208 may also comprise a content database 316. The content database 316 locally stores the items of media 212, the commercial loops 210, and/or associated identifiers used in the media engine 208. Any process for storing and/or locating the items of media 212 and commercial loops 210 may be utilized in association with the content database 316. For example, a hash function may be utilized to index and retrieve the items of media 212 from the content database 316. In a further embodiment, the content database 316 may be located outside of the media engine 208, and is accessible via a media database interface in the media engine 208.

The exemplary media engine 208 shown in FIG. 3 is described as including various components. Alternative embodiments may comprise more or fewer components that those shown and still fall within the scope of embodiments of the present invention.

In exemplary embodiments, a similar version of the media engine 208 may be located at the content provider 216 in order for the content provider 216 to create and modify the commercial loops 210.

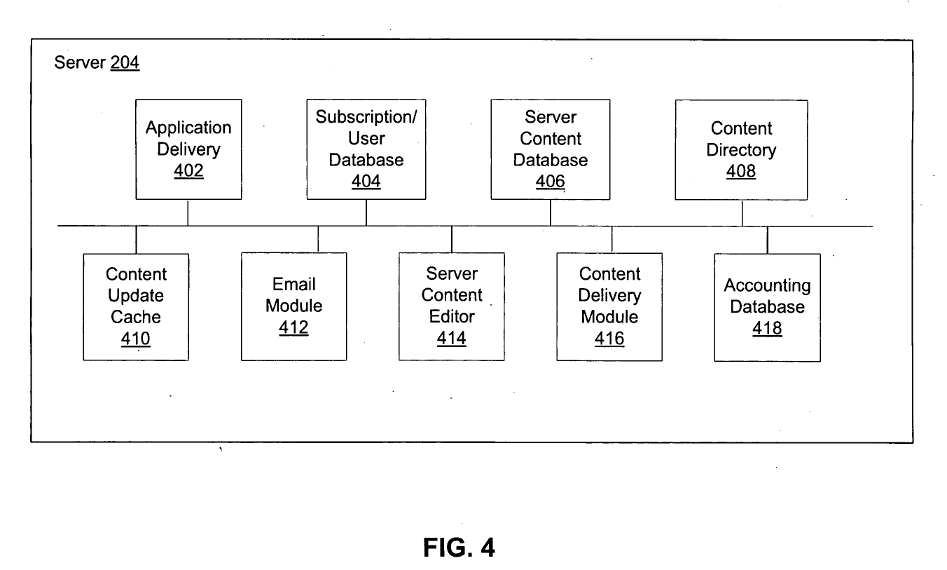

FIG. 4 shows an exemplary embodiment of the server 204 comprising various components associated with providing commercial loops 210. An application delivery module 402 is provided, in various embodiments, for delivering the commercial loops 210, associated items of media 212 that comprise the commercial loops 210, and updates (e.g., modifications) to the commercial loops 210 to the appropriate client (e.g., clients 202 and 214). In an embodiment where the commercial loop 210 is created at the server 204 or the server 204 maintains a master copy of the commercial loop 210, the server 204 can send the commercial loop 210 to the media engine 208 via the application delivery module 402. The application delivery module 402 may also deliver identifiers assigned to the commercial loops 210 to clients 202 and 214.

The exemplary server 204 also comprises various databases including a subscription/user database 404. The subscription/user database 404 stores user information, such as name, email addresses, user identifiers, and any other data relevant for the user. In some embodiments, the user may be required to register certain information with the server 204 before the server 204 will provide the commercial loops 210 to the user. Alternatively, the user may be required to register in order to access the identifiers associated with the commercial loops 210.

In one embodiment, the subscription/user database 404 contains commercial loop subscription information for each user. Thus, a user may subscribe to one or more content providers 216 and/or commercial loops 210. The user will then receive all the commercial loops 210 subscribed to. Furthermore, if any modifications are made to the subscribed-to commercial loops 210, then the user will automatically receive those changes as updates to commercial loops 210. In some embodiments, a content provider 216 will charge a fee for subscribing to their commercial loop 210. In alternative embodiments, the subscription/user database 404 may be located at the content provider 216 providing the subscribed-to commercial loops 210.

Another database of the server 204 is a server content database 406 which may store items of media 212, commercial loops 210, and metadata or configuration information associated with the items of media 212 and the commercial loops 210. As discussed herein, the items of media 212 in the commercial loops 210 may include, for example, photographs, music, graphics, streaming media, animation, movies, graphics, and any other type of visual or audio data.

A content directory 408 may be provided for indexing the content stored in the server content database 406. For example, one or more commercial loops 210 associated with the word “travel” (e.g., in the title) may be retrieved from the server content database 406 via a search of the index in the content directory 408. Any indexing and searching mechanism is within the scope of various embodiments of the present invention. In a further embodiment, the content directory 408 may be included in the server content database 406.

An exemplary content update cache 410 stores the items of media 212 and commercial loops 210 that have been recently updated or modified. According to one embodiment, the content update cache 410 will store the items of media 212 and commercial loops 210 that are currently being used to modify or replace previous versions of the commercial loops 210.

An email module 412 may send electronic mails to, and receive electronic mails from, the content providers 216 and clients 202 and 214. These emails will, for example, provide the receiving client with information for retrieving the items of media 212 or the commercial loop 210. Furthermore, the electronic mails may comprise commands or requests to the server 204, for example, to update a commercial loop 210 with new media 212.

A server content editor 414 allows for modification of the items of media 212 and the commercial loop 210 at the server 204. In one embodiment, the content provider 216 modifies the items of media 212 or the commercial loop 210 using the server content editor 414 via the server 204. In further embodiments, the server content editor 414 has the same functionalities as the content editor 308 of the media engine 208. For example, the server content editor 414 may be used to resize photos, remove red eye, correct color balance, and so forth. In yet further embodiments, the content provider 216 may create the commercial loop 210 using the server content editor 414. For example, a user at the content provider 210 may access the server 204 and using the server content editor 414 create a blank loop and populate it with media 212.

An exemplary content delivery module 416 provides content to be included as one or more items of media 212 in the commercial loop 210. In one embodiment, the content delivery module 416 accesses content stored on, or associated with, the server 204 for the content. In an alternative embodiment, the content may be provided from the content provider 216. In this alternative embodiment, the content delivery module 416 may not be utilized.

In one embodiment, the advertising or content from the content delivery module 416 (or content provider 216) is provided based on an analysis of the user at the client 202. For example, an advertisement for a family vacation to Disneyland® may be included in a travel commercial loop 210 if the user has previously purchased a Disneyland travel package. Therefore, the commercial loops may be customized to the specific user (e.g., client 202). Any manner of determining advertisement or content to be provided may be employed. For example, the customization may be based on past behavior (e.g., spending habits), provided user preferences and interests, types of loops subscribed to, etc.

In an alternative embodiment, the content delivery module 416 (or a version of the content delivery module 416) is located at the content provider 216. In this embodiment, the content provider 216 may customize the media 212 and the commercial loops 210 provided to their client 202. For example, if a particular client 202 has a preference for travel to Europe, the content provider 216 can create a commercial loop 210 or provide media 212 for an existing commercial loop 210 containing special airfares to Europe. This commercial loop 210 or media 212 may then be provided to the specific client 202.

The server 204 may also include an accounting module 418. The accounting module 418 may track the commercial loops 210 and the frequency and type of interaction each of the users has with the commercial loops 210. Specifically, the accounting module 418 can track interaction between the user and the media 212 included in the commercial loop 210. Accordingly, the accounting module 418 can track monies owed to or from a provider of the media 212 based on the user interactions. For example, the content provider 216 may charge for a subscription to a particular commercial loop 210 or for each activation of a media 212 in the commercial loop 210.

Although the server 204 has been described as including various components, more or fewer components may comprise the server 204 in accordance with alternative embodiments. For example, the server 204 may further include a search engine component or a communication interface. In some embodiments, the content provider 216 may embody, comprise, or be the server 204.

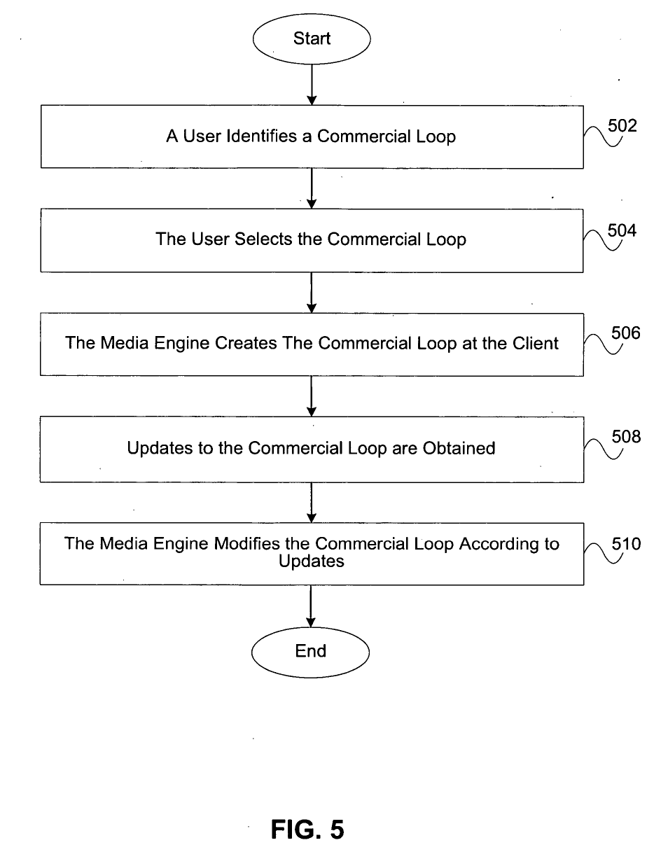

FIG. 5 illustrates a flowchart 500 for maintaining a commercial loop 210 at a client 202, in accordance with one embodiment. At step 502, a user at the client 202 identifies a commercial loop 210 that the user is interested in. As discussed herein, the commercial loop 210 comprises media which can include photos, video, audio, images, text, advertisements, and/or any other type of media. In exemplary embodiments, the commercial loop 210 provides media related to product or services of one or more entities.

The user may find commercial loops 210 or links to commercial loops 210 in various locations. In one embodiment, the user may access commercial loops 210 on an content provider's website. Alternatively, the content provider 216 may send an invitation providing access to the commercial loop 210. In further embodiments, commercial loops 210 may be shared between clients 202 and 214. For example, the client 214 may send an e-mail invitation to client 202 to share the commercial loop 210. Additionally, the commercial loop 210 may also be found by a search performed at the server 204.

At step 504, the user selects the commercial loop 210 that they want to install into their media engine 208. In one embodiment, the user drags the commercial loop 210 to their media engine 208. Alternatively, the user can activates a switch, button, or link that provides a copy of the commercial loop 210 to the media engine 208, or the user can subscribe to a commercial loop 210. In further embodiments, an identifier associated with the commercial loop 210 is stored to the media engine 208 in lieu or, or in addition to, the commercial loop 210, itself. However, any manner of selecting the commercial loop 210 is within the scope of various embodiments.

At step 506, the media engine 208 creates a graphical representation of the commercial loop 210 at the client 202 for display. In one embodiment, the media engine 208 examines the data associated with the commercial loop 210 for specific information. For example, specific information may be included in the data for an image file and the specific information is read by the media engine 208. Based on existence, identification, and/or contents of the specific information, the media engine 208 may undertake particular actions. For example, an identifier for the commercial loop 210 may be included in the specific information. In this embodiment, the media engine 208 may send a request to the server 204 for the commercial loop 210 having the identifier. Any identification and/or examination of data, metadata, and so forth associated with the commercial loop 210, such as the specific information discussed herein, may be employed in accordance with various embodiments. Additionally, the media engine 208 can store the commercial loop 210 in a local database.

If the media engine 208 determines that the commercial loop 210 includes a file folder of one or more items of the media 212, the media engine 208 can extract the media 212 included in the file folder and utilize the media 212 to create or populate the commercial loop 210.

At step 508, updates to the commercial loop 210 are obtained. In one embodiment, the commercial loop 210 comprises a unique identifier. Accordingly, when the content provider 216 modifies the commercial loop 210 having a unique identifier, the server 208 forwards the modifications to the commercial loop 210 at the client 202 sharing the same unique identifier. In alternative embodiments, the media engine 208 requests updates to the commercial loop 210 from the server 204. The request may be event driven (e.g., when the client 202 activates the loop player 102) or occur periodically. Alternatively, the modifications may be provided directly by the content provider 216.

In various embodiments, the server 204 may receive the modifications from the content provider 216, the media engine 208 may request updates from the content provider 216, or the content provider 216 may make the modifications to the commercial loop 210 or copy of the commercial loop 210 stored at the server 204, for example. As discussed herein, the modification may include additions of media to the commercial loop 210, deletions of one or more items of media 212 from the commercial loop 210, and/or modifications to the media 212 in the commercial loop 210. Further, additions, modifications, and/or deletions of the metadata associated with commercial loop 210 may also constitute modifications according to some embodiments.

At step 510, the media engine 208 modifies the commercial loop 210 according to the modifications received. The modifications may comprise one or more items of media 212 or an entire commercial loop 210.

In some embodiments, the commercial loop 210 may be populated with one or more new media 212 by the user. In one example, the user may select to receive a Nascar commercial loop 210 at a Nascar web site. The user may submit their own photographs or other media 212 to the Nascar web site. The photographs or other media 212 received from the user may be selectively or in the entirety placed within the Nascar commercial loop 210. Subsequently, all subscribers to the Nascar commercial loop 210 can receive the photographs or other media 212.

In other embodiments, the commercial loop 210 can be used as a game. In one example, the commercial loop 210 comprises media 212 depicting game pieces. The user may select one or more game pieces within the commercial loop 210. Each time the user makes a selection, the commercial loop 210 may generate a message such as “Try Again” or “You Win”. The number of selections allowed to each user may be limited.

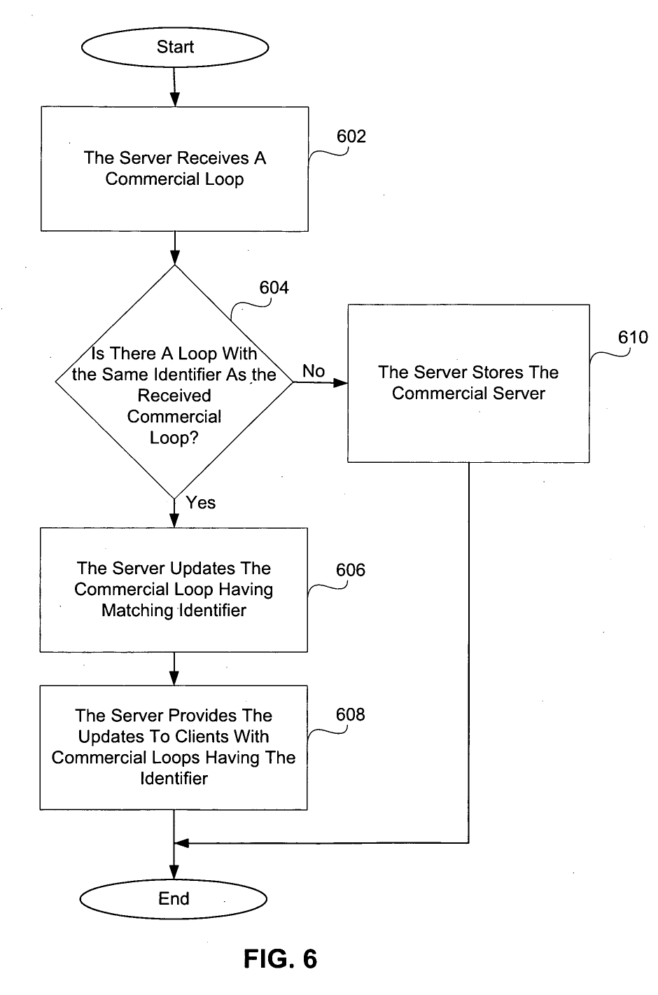

Referring to FIG. 6, an exemplary flow diagram for processing a commercial loop 210 at the server 204 is shown. At step 602, the server 204 receives one or more commercial loops 210 from the content provider 216. Alternatively, the server 204 may receive a copy or a master copy of the commercial loop 210. In some embodiments, the commercial loop 210 may be created at the server 204 rather than at the content provider 216.

At step 604, the server 204 determines whether there is an existing commercial loop 210 with an identifier that matches the identifier associated with the received commercial loop 210. A match will occur if the received commercial loop 210 is a modification of a previous commercial loop 210. If a match occurs, then in step 606, the server 204 updates or replaces the commercial loop 210 having the matching identifier.

At step 608, the server 204 sends the updates to the clients 202 having a commercial loop 210 with the same identifier. In one embodiment, the entire updated commercial loop 210 is sent to the client 202. In an alternative embodiment, only the modifications are sent to the client 202.

If, at step 604, the server 204 determines that there is not a commercial loop 210 with an identifier that matches identifier of the commercial loop 210 received from the content provider 216, the server 204 stores the commercial loop 210 or a copy of the commercial loop 210. The media engine 208 may also store the identifier in the media database server content database 406.

The present invention has been described above with reference to exemplary embodiments. It will be apparent to those skilled in the art that various modifications may be made and other embodiments can be used without departing from the broader scope of the present invention. Therefore, these and other variations upon the exemplary embodiments are intended to be covered by the present invention.

What is claimed is:

1. A method for providing a commercial loop, comprising:
presenting an offer for the commercial loop to the user;
receiving a request from a user for the commercial loop; and
providing the commercial loop to the user upon the request.

2. The method of claim 1 further comprising determining if a modification is available for the commercial loop, and supplying the modification if the modification is available.

3. The method of claim 2 wherein supplying the modification comprises supplying one or more modified media for the selected commercial loop.

4. The method of claim 2 wherein supplying the modification comprises supplying a new commercial loop to replace the selected commercial loop.

5. The method of claim 2 wherein determining if the modification is available comprises determining if the selected commercial loop has a unique identifier associated with the modification.

6. The method of claim 1 further comprising customizing media within the commercial loop for the user.

7. The method of claim 6 wherein customizing the media comprises reviewing preferences of the user to determine appropriate media to provide to the user.

8. The method of claim 6 wherein customizing the media comprises reviewing past behavior of the user to determine appropriate media to provide to the user.

9. The method of claim 1 wherein presenting the offer of the commercial loop comprises providing access to the commercial loop at a website of a content provider.

10. The method of claim 1 wherein receiving the request comprises receiving a subscription for the commercial loop.

11. A system for providing and maintaining a commercial loop, comprising:
a server configured to store the commercial loop and provide the commercial loop to a user upon request;
a content provider configured to provide commercial media associated with the commercial loop; and
a media engine configured to display the commercial loop.

12. The system of claim 11 wherein the content provider is the server.

13. The system of claim 11 further comprising a subscription database configured to store information regarding the user and the commercial loop the user subscribes to.

14. The system of claim 11 further comprising a content directory configured to store an identifier assigned to the commercial loop.

15. The system of claim 11 further comprising a content update cache configured to store at least one modification to the commercial loop.

16. The system of claim 11 further comprising a content editor configured to create one or more modifications to the commercial loop.

17. The system of claim 11 further comprising a content delivery module configured to customize the commercial loop to the user.

18. A machine readable medium having a program embodied thereon, the program providing instructions for a method for providing and maintaining a commercial loop, the method comprising:
presenting an offer for the commercial loop to the user;
receiving a request from a user for the commercial loop; and
providing the commercial loop to the user upon the request.

19. The machine readable medium of claim 18, wherein the method further comprises determining if a modification is available for the commercial loop, and supplying the modification if the modification is available.

20. The machine readable medium of claim 18, wherein the method further comprises customizing media within the commercial loop for the user.
